(19) United States
(12) Patent Application Publication
(10) Pub. No.: US 2009/0299806 A1
(43) Pub. Date: Dec. 3, 2009

(54) METHOD AND APPARATUS FOR DEMAND AND/OR SKILL HEDGING

(75) Inventors: Yingdong Lu, Yorktown Heights, NY (US); Aleksandra Mojsilovic, New York, NY (US); Mark S. Squillante, Pound Ridge, NY (US); Samer Takriti, Croton on Hudson, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/127,358

(22) Filed: May 27, 2008

(51) Int. Cl. G06Q 90/00

(52) U.S. Cl. 705/9; 705/10; 235/376; 705/8

(57) ABSTRACT

A risk management method and system determine distribution of skills, composition of skills and resources to achieve said distribution, a set of actions to achieve said composition, a portfolio of service and/or product offerings, a composition of staffing plans to achieve said portfolio, and a set of demand conditioning actions to achieve said composition, in order to hedge against uncertainty based on demand information, risk information, product and/or service revenue and information, and skill cost and information, while meeting business objectives.

### FIELD OF THE INVENTION

The present application is related generally to workforce related risk managements and more particularly, to a method and apparatus for demand/skill hedging.

### BACKGROUND OF THE INVENTION

A company's ability to deliver products, grow revenue and profit depends largely on how well the company can handle workforce management. In order to deliver successful labor-based product and services, the right people with the right skills should be available to handle the service delivery as needed. Companies have recently begun to invest in methodologies that determine the “best” skill needs to satisfy forecasted demand for products, services, projects, works, and like. Forecasting, however, invariably involves uncertainties and risks in that the forecasted numbers may not reflect accurate projections.

No current solutions allow for dynamic computation of a flexible and robust workforce distribution and portfolio of product/service offerings that enable a company to meet a variety of future demands and market volatility while achieving business objectives and addressing labor and human resource costs, product/service revenue and business and market risks. Thus, what is desirable is a method and system that would be able to handle such inaccurate or near miss forecasts, and hedge against possible uncertainties and risks.

### BRIEF SUMMARY OF THE INVENTION

A method and system for demand and/or skill hedging are provided. In one aspect, the method may comprise identifying one or more hedge components; identifying at least one risk management solution associated with said one or more hedge components; and correlating the hedge components with said risk management solution to hedge against an uncertainty.

In another aspect, a method for skill hedging may comprise determining distribution of skills according to one or more selected criteria; determining composition of resources that satisfy said distribution of skills; and determining one or more actions for achieving distribution of skills and/or said composition of resources.

A system for demand hedging, in one aspect, may comprise means for determining portfolio of product offerings according to one or more selected criteria; means for determining composition of delivery plans that fulfill said portfolio of product offerings; and means for determining one or more demand conditioning actions for achieving portfolio of product offerings and/or said composition of delivery plans.

A system for demand and/or skill hedging, in one aspect, may comprise means for identifying the dependence between different components within skill hedging and demand hedging, and dependence between skill hedging and demand hedging; and means for determining the related changes if any one of the components changes because of internal or external factors.

A program storage device readable by a machine, tangibly embodying a program of instructions executable by the machine to perform the above methods for demand and/or skill hedging may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates components of the system of the present disclosure in one embodiment and information flow among the components.

FIG. 2 illustrates functional components of the system of the present disclosure in one embodiment for demand hedging and information flow among the components.

FIG. 3 illustrates feedback arrangement among the components of the system in one embodiment.

### DETAILED DESCRIPTION

A risk management method and system are provided that determine best or nearly best distribution of skills, best or nearly best skill composition resources, best or nearly best set of actions to achieve said distribution and composition, best or nearly best portfolio of product and/or service offerings, best or nearly best composition of delivery plans to achieve said portfolio of product and/or service offerings, and best or nearly best set of demand conditioning actions to achieve said composition of delivery plans, and that hedge against the uncertainties based on demand information, risk information, product and/or service revenue and information, skill cost and information, and like, while meeting business objectives. In sum, the method and system of the present disclosure allow for mitigating risks associated with demand forecasting and maximizing profits.

Best or nearly best distribution of skills refers to the amount of different skills that an entity (e.g., an industry, a company, a unit within a company, etc.) should possess overall according to any criteria desired by the entity. Examples of this criteria for best or nearly best may include but are not limited to any set of functions of profit, revenue, cost, market share, customer satisfaction, employee satisfaction, business strategy, business objectives, any risks associated with overall skills distribution, various sources of uncertainty, etc. Any one or combinations of the criteria may be used. Distribution of skills may be the amount of each skill owned by the entity, borrowed from other entities, obtained through outsourcing, business partnerships, vendors, etc., and so on, and is such that risks associated with the distribution of skills can be hedged. A representative example of a best or nearly best distribution of skills may include the amount of each skill involved in a unit within an information technology (IT) service company, such as 100 software engineers, 50 infrastructure architects, 75 project managers, 100 consultants, etc. Other representations are possible and the method of the present disclosure does not limit the representation to this particular example.

Best or nearly best skill composition of resources refers to a mapping of the above distribution of skills overall to the resources available to an entity, for example, individual employees or groups of individuals, according to any criteria desired by the entity. Examples of this criteria for best or nearly best may include but are not limited to any set of functions of profit, revenue, cost, market share, customer satisfaction, employee satisfaction, business strategy, business objectives, any risks associated with skill composition of resources, various sources of uncertainty, etc. Any one or combinations of the criteria may be used. Composition of resources can include the number of resources that have different compositions of skills so that the distribution of the skills can be achieved overall while at the same time hedging the risks associated with the skill composition of resources. A representative example of a best or nearly best skill composition of resources for an information technology (IT) service company may include the number of resources that possess different compositions of skills to achieve the above representative example for distribution of skills overall, such as 50 people with software engineering and infrastructure architecture skills, 75 people with infrastructure architecture, project management and consulting skills, 150 people with software engineering, project management and consulting skills, 50 people with software engineering and consulting skills, etc. Other representations are possible and the method of the present disclosure does not limit the representation to this particular example.

Best or nearly best set of actions to achieve the above distribution of skills and composition of skills and resources refers to the various actions that an entity (e.g., an industry, a company, a unit within a company, etc.) can take over time to transform its workforce from the current state to a future state of interest according to any criteria desired by the entity, including the best or nearly best distribution of skills and/or the best or nearly best skill composition. This criteria for best or nearly best may include but are not limited to any set of functions of profit, revenue, cost, market share, customer satisfaction, employee satisfaction, business strategy, business objectives, any risks associated with the set of actions taken over time, various sources of uncertainty, etc. Any one or combinations of the criteria may be used. Examples of this set of actions taken over time may include but are not limited to the amount of hiring, retraining, attrition, etc. of resources in order to move from the existing workforce state to achieving the best or nearly best skill composition, for example, with the least cost, highest revenue/profit, and/or in the least amount of time, all while at the same time hedging the risks associated with workforce actions. A representative example of a best or nearly best set of workforce actions for an information technology (IT) service company may include the number of resources with different compositions of skills obtained through hiring, retraining, attrition, etc., as well as the duration required for hiring, retraining, attrition, etc, to achieve the above representative example for distribution of skills overall and skill composition of resources, such as hiring 20 people with software engineering and infrastructure architecture skills, retraining 25 people for 4 weeks with infrastructure architecture and project management skills to also have consulting skills, retraining 50 people for at least a year with project management and consulting skills to also have software engineering skills, attrition of 10 people with software engineering and consulting skills, etc. Other representations are possible and the method of the present disclosure does not limit the representation to this particular example.

Best or nearly best portfolio of product offerings refers to the amount of different types of product offerings that an entity (e.g., an industry, a company, a unit within a company, etc.) should provide overall according to any criteria desired by the entity. Examples of this criteria for best or nearly best may include but are not limited to any set of functions of profit, revenue, cost, market share, customer satisfaction, employee satisfaction, business strategy, business objectives, any risks associated with overall product offerings portfolio, various sources of uncertainty, current and/or future workforce, etc. Any one or combinations of the criteria may be used. Portfolio of product offerings may include but are not limited to which products to offer, the amount of each of these product offerings, how these offerings are offered or provided (e.g., solely through the entity, through business partnerships, through combination with vendors, etc.), and so on, and is such that one or more risks associated with the portfolio of product offerings can be hedged. A representative example of a best or nearly best portfolio of product offerings may include the different types of products offered by an IT service company and the amount of each product offering for different industries/sectors and different types of customers, such as a simple network service product with a delivery target of 1000 instances, a complex network service product with a delivery target of 200 instances, a simple database service product with a delivery target of 400 instances, a complex database service product with a delivery target of 20 instances, etc. Other representations are possible and the method of the present disclosure does not limit the representation to this particular example.

Best or nearly best composition of delivery plans refers to a mapping of the above portfolio of product offerings overall to the resources and skill composition of resources (e.g., individual employees, groups of employees, etc.) available to an entity (e.g., an industry, a company, a unit within a company, etc.) according to any criteria desired by the entity. Examples of this criteria for best or nearly best may include but are not limited to any set of functions of profit, revenue, cost, market share, customer satisfaction, employee satisfaction, business strategy, business objectives, any risks associated with composition of delivery plans, various sources of uncertainty, etc. Any one or combinations of the criteria may be used. Composition of delivery plans may include the amount of resources and compositions of skills in order to deliver each product offering so that the portfolio of product offerings can be achieved overall. Composition of delivery plans may be such that the risks associated with the composition of delivery plans can be hedged. A representative example of a best or nearly best composition of delivery plans for an information technology (IT) service company may include the number of resources and compositions of skills to achieve the above representative example for portfolio of product offerings overall, such as a simple network service product involving 1 network specialist and 1 network consultant, a complex network service product involving 3 network specialists, 2 network consultants, 1 software engineer and a project manager, etc. Other representations are possible and the method of the present disclosure does not limit the representation to this particular example.

Best or nearly best set of demand conditioning actions to achieve the above portfolio of product offerings and composition of delivery plans refer to the various actions that an entity (e.g., an industry, a company, a unit within a company, etc.) can take over time to transform the marketplace demands from its current state to a future state of interest according to any criteria desired by the entity, including the best or nearly best portfolio of product offerings and/or the best or nearly best delivery plan composition. Examples of this criteria for best or nearly best may include but are not limited to any set of functions of profit, revenue, cost, market share, customer satisfaction, employee satisfaction, business strategy, business objectives, any risks associated with the set of actions taken over time, various sources of uncertainty, etc. Any one or combinations of the criteria may be used. Set of demand conditioning actions taken over time may include the amount of selectively accepting business commitments, the amount and degree of dynamic pricing mechanisms (e.g., price incentives), various mechanisms to exploit price elasticity, all while at the same time hedging the risks associated with demand conditioning. A representative example of a best or nearly best set of demand conditioning actions for an information technology (IT) service company may include the amount of business commitments included with the purchase of selective product offerings by selective customers, the amount of price incentives included with the purchase of selective product offerings, etc. to achieve the above representative example for portfolio of product offerings overall and composition of delivery plans, such as bundling additional services (either for free or at a significant discount) for favored customers when they purchase certain product offerings of interest, reducing the price of certain product offerings in general, further reducing the price of product offerings when purchased at certain levels, etc. Other representations are possible and the method of the present disclosure does not limit the representation to this particular example.

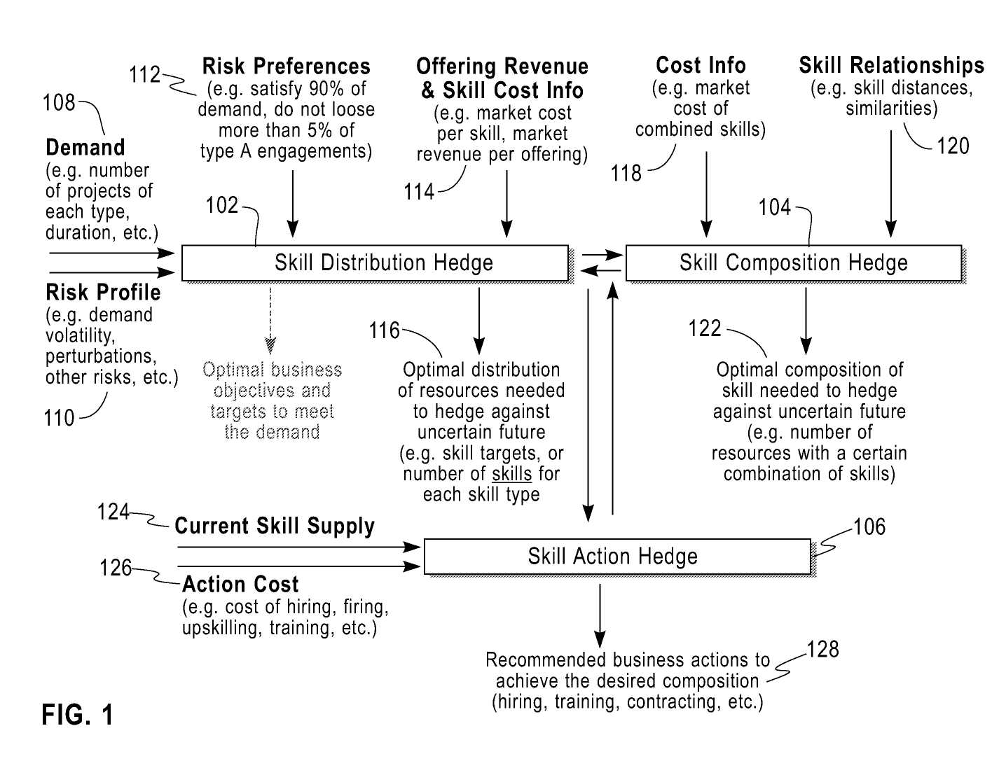

FIG. 1 illustrates functional components of the system of the present disclosure in one embodiment for skill hedging and information flow among the components. Skill distribution hedging functional component 102 considers skills as financial assets and determines the best or nearly best distribution of skills, with input information such as demand information 108, risk profile 110, risk preference 112, and offering revenue and skill cost information 114. For example, this model may determine the portfolio of resources 116 that is considered optimal, for instance, the number and amount of resources owned by the firm (e.g., employees) and those obtained through outsourcing needed to hedge against uncertain future. The criterion for determining best and nearly best distribution of skills may be based on a reward function of profit, revenue, cost, market share, customer satisfaction, employee satisfaction, business strategy, business objectives, any risks associated with overall produce offerings portfolio, various sources of uncertainty, current and/or future workforce, etc., or any combinations thereof.

Different dynamics for a reward function may be governed by mathematical equations, and for example, may be represented by a stochastic differential equation as follow:

dPᵢ(t)=bᵢdt+σᵢdWᵢ(t),

dPₒ(t)=bₒdt+σₒdWₒ(t),

where, bᵢ and bₒ represent the trend of the corresponding changes of the rewards, σᵢ and σₒ represent the magnitude of uncertainty of various sources, and dWᵢ(t) and dWₒ(t) are measures induced by stochastic processes. A representative example is the Wiener measure. The parameters bᵢ, bₒ, σᵢ, and σₒ are all determined by demand information, risk profile and offering revenue and skill cost information.

A representative example of skill distribution hedge problem may take the following form:

$$sup E {\int }_{0}^{T} {U}_{1} ( {P}_{i} ( t ) , {P}_{o} ( t ) , {π}_{i} ( t ) , {π}_{o} ( t ) ) d t$$

$$s . t . {U}_{2} ( {P}_{i} ( t ) , {P}_{o} ( t ) , {π}_{i} ( t ) , {π}_{o} ( t ) ) \geq L ( t ) , \\ {π}_{i} ( t ) + {π}_{o} ( t ) = B ,$$

where the variables πᵢ and πₒ denote the proportion of a firm's investment in in-house resources or outsourced resource respectively; U₁ is the utilities function that measures the gain in profit, revenue, cost, market share, customer satisfaction, employee satisfaction, business strategy, business objectives, any risks associated with overall produce offerings portfolio, various sources of uncertainty, current and/or future workforce, etc., and may be determined again by demand information, risk profile and offering revenue and skill cost information, as well as the two stochastic differential equations of Pᵢ(t) and Pₒ(t), which can take form in profit, market share, etc.; U₂ and L are utility functions and constraints that reflect risk preferences, service level guarantees, etc. Various methods of stochastic control can be applied to obtain the solutions to the above problem. The output may include πᵢ and πₒ, the best or nearly best distribution of skills in the form of company's investment strategy. An objective may be the expected business goal (i.e., E), for example, revenue or profit, which is a function of the actions taken, reflected by the investment policy πᵢ and πₒ, and cumulative over time. The constraint usually reflects physical and contractual restrictions that a company's investment has to follow such as service level guarantees. The constraint may be determined by demand information, risk profile and offering revenue and skill cost information, as well as the two stochastic differential equations of Pᵢ(t) and Pₒ(t), which can take form in profit, market share, etc. These type of optimization can be solved by, but not limited to, stochastic dynamic programming, stochastic optimal control.

In one embodiment, skill distribution hedge 102 takes parameters or attributes such as demand 108, risk profile 110, risk preferences 112, and offering revenue and skill cost information 114 as input, and uses mathematical approach to hedge skill distribution taking into consideration business objectives and targets to meet the demand. Examples of demand 108 may include but are not limited to number of projects of each type, duration, due dates, etc., that is requested, for example, from a customer or client to be serviced. Examples of risk profile 110 may include but are not limited to volatility in demand forecast, perturbations, and/or other risks, etc. Examples of volatility in demand forecast include an expectation of demand with cumulative forecasting errors at a rate of ±15%. Risk preference 112 may specify conditions or constraints such as “satisfy 90% of demand, and do not loose more than 5% of type A engagements.” Offering revenue and skill cost information 114 may specify market cost per skill, market value per offering which may include the revenue and profits associated to the offering and their impact on the market share, and like. Lead time parameters or time factors, such as the length of the time periods required for hiring and retraining of skills, might be other parameters that are input to the skill distribution hedge 102. Skill distribution hedge model 102 outputs the best or nearly best distribution of skills 116 needed to hedge against uncertain future, for example, skill targets or number of skills for each skill type. Examples of future uncertainties include future economic conditions, response of the market place to new offerings, and changing response of the market place to existing offerings.

Skill composition hedging functional component 104 considers resources as bundles of financial assets and determines best or nearly best composition of skills 122, with input of best or nearly best distribution of skill (e.g., obtained at skill distribution hedge 102), cost information 118 and skill relationships 120. In a representative example, an optimization problem is formulated to determine the skill composition. Input to this model may include, {πᵢ(t)} (the proportion of a firm's investment that are invested in in-house resources), a portfolio of resource requirements obtained from the skill distribution hedge 102 for all the skills, and cost information on resources (employees).

As an optimization model, skill composition hedge 104 determines n_{K}, the amount of resources that have skill combination of K, where K is a subset of all the skills. This model may be expressed as a reward maximization problem in one embodiment. An example of a dynamic optimization problem that is formulated and solved in the skill composition hedge model 104 is as follow:

$$min E {\int }_{0}^{T} {\sum }_{i} {c}_{i 1} ( {π}_{i} ( t ) , {\sum }_{K ∋ i} {n}_{K} {x}_{iK} ( t ) ) d t + {\sum }_{i} {c}_{i 2} ( {π}_{i} ( t ) , {\sum }_{K ∋ i} {n}_{K} {x}_{iK} ( t ) ) d t$$

$$s . t . {\sum }_{i ∈ K} {x}_{iK} ( t ) \leq 1$$

where, x_{iK}(t) denotes the potential assignment for resource type K to skill i, and cᵢ₁ and cᵢ₂ are the penalty functions for the skill level to go above or below the amount of skills provided by best or nearly best distribution of skills, and the summation in the objective is taken over all the skills. Various methods of stochastic control can be applied to obtain the solutions to the above problem. For example, the problem may be expressed as a stochastic optimal control problem, routine numerical methods, such as discretization and dynamic program, and can be applied to obtain the solutions. The output of the model includes the best or nearly best skill combination. As a simplified example, the algorithm may determine the number of people with each combination of skills such that the overall skill distribution (102) is satisfied.

In one embodiment, skill composition hedge 104 takes cost information 118 such as market cost of combined skills (the market cost of having a person with multiple skills and/or a collection of people having a skill and/or both), costs associated with maintaining a set of skills, and skill relationships 120 such as skill distances (the cost associated to transform a person with one skill to that with another skill) and similarities, and obtains an optimal composition of skills needed to hedge against uncertain future, for instance, using a mathematical model. Optimal composition of skills 122 provides a number of resources (human or otherwise) with a certain combination of skills or like.

Skill action hedging functional component 106 considers current supply at t=0 with goal of minimizing deviations from optimal portfolio risk management at t=T while maximizing profits or revenues within financial assets framework. A feedback loop iteratively refines the solutions of each skill hedge components based on the solution of other skill hedge components shown in FIG. 1.

In one embodiment, skill action hedge 106 takes current skill supply 124 and action cost 126 such as cost of hiring, attrition, upskilling, training, etc., and recommends business actions 128 to achieve the desired composition. Recommended business actions may include a ratio or percentage of hiring, training, contracting of resources.

Given the optimal number of resources such as employees obtained by the skill composition 104, and the current status of the resource composition, a skill action problem may be formulated to determine the action that can be taken to achieve the optimal composition. As a representative example, the skill action problem may take the form of a stochastic optimal control problem as follows:

$$min {\int }_{0}^{T} \vert C ( {n}_{K} ( t ) , {\hat{n}}_{K} ( t ) , u ( t ) ) \vert d t$$

$$s . t . \frac{d}{d t} {\hat{n}}_{K} ( t ) = f ( {\hat{n}}_{K} ( t ) , u ( t ) ) , \\ {\hat{n}}_{K} ( 0 ) = {\hat{n}}_{K} ,$$

where n_{K} is the optimal skill composition, \hat{n}_{K} is the current skill composition, u(t) the actions. Function ƒ describes the reaction of the workforce under these actions, and C is the utility function that reflects both the distance between n_{K} and \hat{n}_{K} the cost of action u(t). n_{K} is the target state, \hat{n}_{K} is the current state. Dynamic program can be used to obtain the solutions to this type of stochastic optimal control problems. As a simplified example, the skill action algorithm determines the hiring, retraining and releasing actions to achieve the optimal skill distribution (102) and/or optimal skill composition (104).

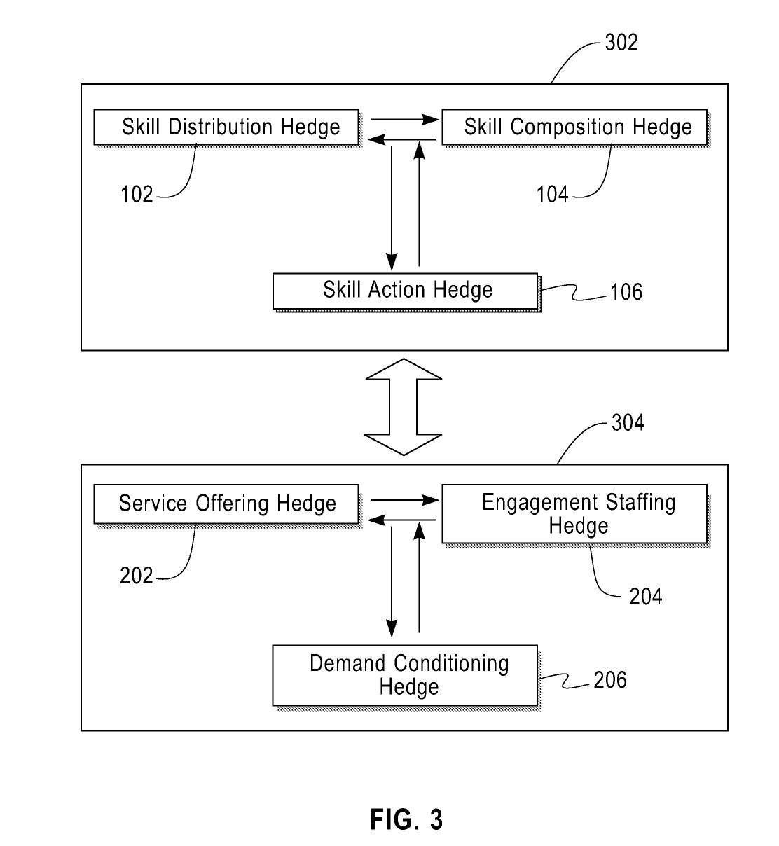

The hedge components 102, 104, and 106 may form a feedback loop system, where outputs are iteratively fed into one another to further produce updated outputs. Any combination of feedback loop arrangement is possible with the three hedge components, as illustrated in FIG. 3, 302.

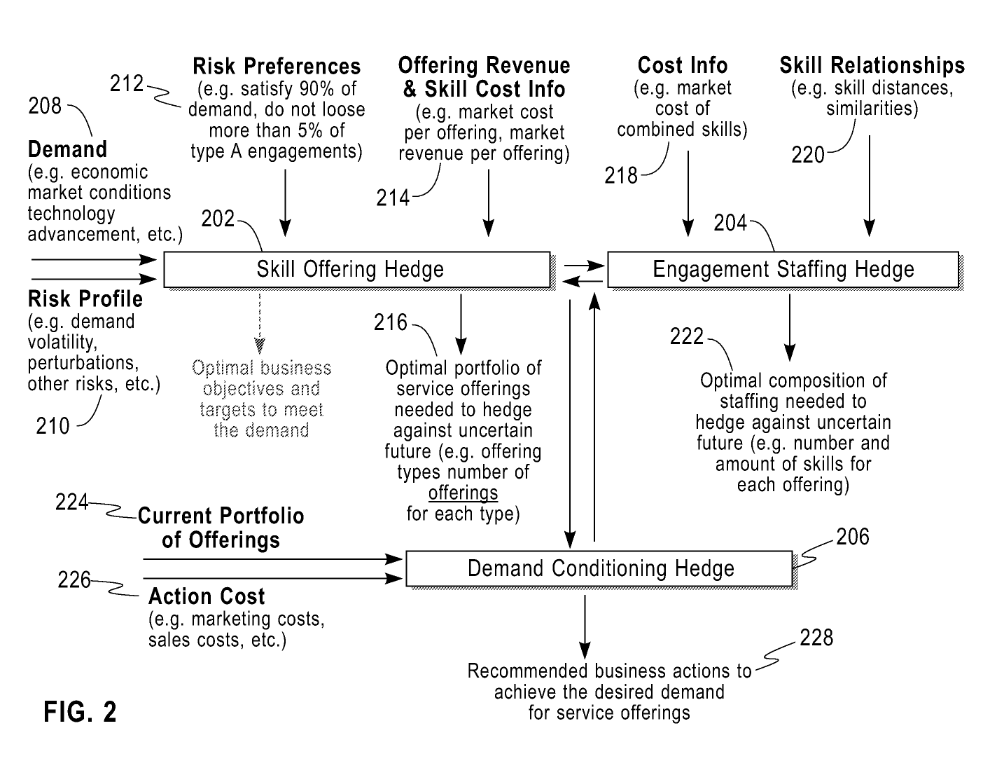

FIG. 2 illustrates functional components of the system of the present disclosure in one embodiment for demand hedging and information flow among the components. Demand hedging focuses on the demand side of the business, for instance, what items or products to offer based on the available supply. Service offering hedge functional component 202 takes parameters such as demand 208, risk profile 210, risk preferences 212 and offering revenue and skill cost information 214, for example, and formulates and uses a mathematical model to determine the best or nearly best portfolio of product (and/or service) offerings 216 needed to hedge against uncertain future. A representative example of the mathematical model may take the following form,
max ƒ(x₁, x₂, . . . , xₙ),
s.t. g(x₁, x₂, . . . , xₙ)=0,
   where x₁, x₂, . . . , xₙ are the numbers of different product offerings, the criterion of best or nearly best is represented by the reward function ƒ determined by profit, revenue, cost, market share, customer satisfaction, employee satisfaction, business strategy, business objectives, any risks associated with overall produce offerings portfolio, various sources of uncertainty, current and/or future workforce, etc., as well as the parameters such as demand, risk profile, risk preferences and offering revenue and skill cost information; function g is a utility function representing the business constraint, as well as the parameters such as demand, risk profile, risk preferences and offering revenue and skill cost information. Mathematical tools can be used to efficiently search among all the feasible x₁, x₂, . . . , xₙ, that is, those that satisfy g(x₁, x₂, . . . , xₙ)=0, to find the one that has the maximum value of ƒ(x₁, x₂, . . . , xₙ). The mathematical techniques that can be used to obtain this solution include but not limited to dynamic programming, stochastic optimal control and mathematical programming.

The produced best or nearly best portfolio of product offerings may specify offering types and the number of offerings for each type subject to any business objectives and targets to meet the demand. Examples of demand 208 input may include but are not limited to economic factors (e.g., interest rate, exchange rate), market conditions (e.g., competition position, competitor strategy), technology advancement (e.g., new product introduction, demands generated by the development and deployment of new technologies), etc. Examples of risk profile 210 input may include but are not limited to uncertainty associated with the demand and supply processes that could potentially have significant impacts on the business processes, such as, demand forecast volatility, perturbations, other risks, etc. Risk preference 212 may specify conditions or constraints such as “satisfy 90% of demand, and do not loose more than 5% of type A engagements.” Offering revenue and skill cost information 214 may specify market cost per skill, market revenue per offering which is consists of the revenue and profits associated to the offering and its impact of the market share, and like.

Engagement staffing hedge functional component 204 takes parameters such as cost information 218 (e.g. market costs of combined skills) and skill relationships 220 (e.g. skill distance, similarities), best and nearly best portfolio of product offering obtained in service offering hedge 202 as input, and uses a similar mathematical model to compute or determine best or nearly best composition of delivery plans composition 222 needed to hedge against uncertain future. The best and nearly best composition 222 specifies the number and amount of skills for each offering. The input cost information 218 may be data associated with the market cost of combined skills. The input skill relationships 220 may include skill distances or similarities.

A representative example of the mathematical model for a product offering may take the similar form,
max ƒ(x₁, x₂, . . . , xₙ),
s.t. g(x₁, x₂, . . . , xₙ)=0,
   where x₁, x₂, . . . , xₙ are the amount of different skills required for this product offering, the criterion of best or nearly best is represented by the reward function ƒ determined by profit, revenue, cost, market share, customer satisfaction, employee satisfaction, business strategy, business objectives, any risks associated with overall produce offerings portfolio, various sources of uncertainty, current and/or future workforce, etc., as well as the parameters such as demand, risk profile, risk preferences and offering revenue and skill cost information; function g is a utility function representing the business constraint for the success of this product offering, as well as the parameters such as demand, risk profile, risk preferences and offering revenue and skill cost information. Mathematical tools can be used to efficiently search among all the feasible x₁, x₂, . . . , xₙ, that is, those that satisfy g(x₁, x₂, . . . , xₙ)=0, to find the one that has the maximum value of ƒ(x₁, x₂, . . . , xₙ). Similar optimization problems may be formatted and solved for each product offering. The mathematical techniques that can be used to obtain this solution include but not limited to dynamic programming, stochastic optimal control and mathematical programming.

Demand conditioning hedge functional component 206 uses data such as the current portfolio of offerings 224 and action costs 226 (e.g. marketing costs, sales costs, etc.), outputs best or nearly best set of demand conditioning actions 228. A representative example of the mathematical model for demand conditioning may take the following form,

$$max {\int }_{0}^{T} f ( {x}_{1} , {x}_{2} , … , {x}_{n} , t ) d t , \\ s . t . g ( {x}_{1} , {x}_{2} , … , {x}_{n} , t ) = 0 ,$$

where x₁, x₂, . . . , xₙ are the quantification of demand conditioning actions taken over time. These actions may include the amount of selectively accepting business commitments, the amount and degree of dynamic pricing mechanisms (e.g. pricing incentives), various mechanisms to exploit price elasticity. The criterion of best or nearly best may be represented by the reward function ƒ determined by factors such as profit, revenue, cost, market share, customer satisfaction, employee satisfaction, business strategy, business objectives, any risks associated with overall produce offerings portfolio, various sources of uncertainty, current and/or future workforce, etc., and the parameters such as demand, risk profile, risk preferences and offering revenue and skill cost information; function g is a utility function representing the business constraint for taking these actions, and may also include parameters such as demand, risk profile, risk preferences and offering revenue and skill cost information. Mathematical tools can be used to efficiently search among all the feasible x₁, x₂, . . . , xₙ over time, that is, those that satisfy g(x₁, x₂, . . . , xₙ, t)=0 for any time t, to find the one that has the maximum value of the objective. The mathematical techniques that can be used to obtain this solution include but not limited to dynamic programming, deterministic and stochastic optimal control.

The hedge components shown in FIG. 2 may be arranged to form a feedback loop, wherein an output from a hedging function 202, 204, or 206 is used as inputs to the other hedging functions 202, 204, 206.

In addition, the output from the skills hedge components shown in FIG. 1 may be used as input to demand hedging components shown in FIG. 2, and vice verse, forming another layer of a feedback system as shown in FIG. 3. At any stage of planning, an iterative procedure may be conducted to guarantee the consistency between the skill hedge components and the demand hedge components. Skill hedge components may be calculated with product offerings, delivery plan and demand conditioning actions given, then the output in the form of distribution of skills, skill composition and skill actions may become inputs to the demand hedge component, which in turn produces a new set of product offerings, delivery plan and demand conditioning actions, feeding into the skill hedge components as a modified input. After several iterations as described, the skill hedge components and the demand hedge components will be in agreement for a common business objective.

Over time, the business conditions for the calculations of the skill hedge components and the demand hedge components will change. The changes may include internal changes such as organizational changes, external changes such as changes in market conditions, and intrinsic change in the course of business. When these changes occur, one or more components may be recalculated with the changed parameters that reflecting the changes of the business conditions. Recalculated values initiate another iterative procedure as described above so that all the components are adjusted as a result of the changed business conditions.

Various aspects of the present disclosure may be embodied as a program, software, or computer instructions embodied in a computer or machine usable or readable medium, which causes the computer or machine to perform the steps of the method when executed on the computer, processor, and/or machine.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer-implemented method for hedging risks in forecasted supply and demand of resources, comprising:
identifying one or more hedge components;
identifying at least one risk management solution associated with said one or more hedge components; and
correlating the hedge components with said risk management solution to hedge against an uncertainty.

2. The method of claim 1, wherein said one or more hedge components include one or more skill hedge components.

3. The method of claim 1, wherein said one or more hedge components include product, project, service, or work hedge components, or combinations thereof.

4. The method of claim 1, wherein said one or more hedge components include skill hedge components and product, project, service or work hedge components, and the step of correlating includes balancing said skill hedge components and said product, project, service or work hedge components to hedge against an uncertainty.

5. A computer-implemented method for hedging risks in forecasted supply and demand of resources, comprising:
determining distribution of skills according to one or more selected criteria;
determining composition of resources that satisfy said distribution of skills; and
determining one or more actions for achieving distribution of skills and said composition of resources.

6. The method of claim 5, wherein said steps of determining distribution of skills, composition of resources, and one or more actions are iteratively performed using determined distribution of skills, composition of resources, and one or more actions as input parameters fed back into the steps of determining.

7. The method of claim 5, further including:
determining a portfolio of product offerings according to one or more selected second criteria;
determining a composition of staffing needed to deliver said portfolio of product offerings; and
determining one or more demand conditioning actions that satisfy said portfolio of product offerings and said composition of staffing, said one or more demand conditioning actions including recommended actions for achieving a selected demand associated with said portfolio of product offerings.

8. The method of claim 7, wherein said steps of determining a portfolio of product offerings, a composition of staffing, and one or more demand conditioning actions are iteratively performed using determined portfolio of product offerings, composition of staffing, and one or more demand conditioning actions as input parameters fed back into the steps of determining a portfolio of product offerings, a composition of staffing, and one or more demand conditioning actions.

9. The method of claim 7, wherein said determined portfolio of product offerings, composition of staffing, and one or more demand conditioning actions are fed back into the steps of determining distribution of skills, composition of resources, and one or more actions and used as input parameters.

10. The method of claim 7, wherein said determined distribution of skills, composition of resources, and one or more actions are fed back into the steps of determining a portfolio of product offerings, a composition of staffing, and one or more demand conditioning actions and used as input parameters.

11. The method of claim 5, wherein said step of determining distribution of skills includes solving a stochastic optimization problem subject to said selected criteria as one or more constraints.

12. The method of claim 5, wherein said step of determining composition of resources that satisfy said distribution of skills includes formulating and solving a stochastic dynamic optimization problem.

13. The method of claim 5, wherein said step of determining one or more actions includes formulating and solving a stochastic dynamic optimization problem.

14. A system for hedging risks in forecasted supply and demand of resources, comprising:
a processor;
means for determining distribution of skills according to one or more selected criteria;
means for determining composition of resources that satisfy said distribution of skills; and
means for determining one or more actions for achieving distribution of skills and said composition of resources.

15. The system of claim 14, further including:
means for determining a portfolio of product offerings according to one or more selected second criteria;
means for determining a composition of staffing needed to deliver said portfolio of product offerings; and
means for determining one or more demand conditioning actions that satisfy said portfolio of product offerings and said composition of staffing, said one or more demand conditioning actions including recommended actions for achieving a selected demand associated with said portfolio of product offerings.

16. A program storage device readable by a machine, tangibly embodying a program of instructions executable by the machine to perform a method of hedging risks in forecasted supply and demand of resources, comprising:
determining distribution of skills according to one or more selected criteria;
determining composition of resources that satisfy said distribution of skills; and
determining one or more actions for achieving distribution of skills and said composition of resources.

17. The program storage device of claim 16, wherein said steps of determining distribution of skills, composition of resources, and one or more actions are iteratively performed using determined distribution of skills, composition of resources, and one or more actions as input parameters fed back into the steps of determining.

18. The program storage device of claim 16, further including:
determining a portfolio of product offerings according to one or more selected second criteria;
determining a composition of staffing needed to deliver said portfolio of product offerings; and
determining one or more demand conditioning actions that satisfy said portfolio of product offerings and said composition of staffing, said one or more demand conditioning actions including recommended actions for achieving a selected demand associated with said portfolio of product offerings.

19. The program storage device of claim 18, wherein said steps of determining a portfolio of product offerings, a composition of staffing, and one or more demand conditioning actions are iteratively performed using determined portfolio of product offerings, composition of staffing, and one or more demand conditioning actions as input parameters fed back into the steps of determining a portfolio of product offerings, a composition of staffing, and one or more demand conditioning actions.

20. The program storage device of claim 18, wherein:
said determined portfolio of product offerings, composition of staffing, and one or more demand conditioning actions are fed back into the steps of determining distribution of skills, composition of resources, and one or more actions and used as input parameters; and
said determined distribution of skills, composition of resources, and one or more actions are fed back into the steps of determining a portfolio of product offerings, a composition of staffing, and one or more demand conditioning actions and used as input parameters.
